(19) United States
(12) Patent Application Publication
(10) Pub. No.: US 2005/0016922 A1
(43) Pub. Date: Jan. 27, 2005

(54) Preferential precipitation membrane system and method

(76) Inventors: Ronald J. Enzweiler, Moraga, CA (US); Peter Allan, Santa Rosa, CA (US); Jurgen Heinz Strasser, Lafayette, CA (US)

Correspondence Address: RATNERPRESTIA, P O BOX 980, VALLEY FORGE, PA, 19482-0980, US

(21) Appl. No.: 10/807,044

(22) Filed: Mar. 23, 2004

Related U.S. Application Data
(60) Provisional application No. 60/457,074, filed on Mar. 24, 2003.

(51) Int. Cl. B01D 11/00

(52) U.S. Cl. 210/639; 210/641; 210/644; 210/259; 210/321.6

(57) ABSTRACT

A system and method for desalinating a feed solution containing a high level of sparingly soluble solutes, such as calcium sulfate, in which a high percentage of the water content of the feed solution is recovered as purified water. The method and system comprise introducing a sufficient quantity of nucleation crystals on the low pressure side of a first-pass membrane separation unit so that the sparingly soluble solutes precipitate on the suspended nucleation crystals, instead of on the surface of the first-pass semi-permeable membrane barrier. The permeate from the first-pass membrane separation unit is then sent to the high pressure side of a second-pass membrane separation unit. The second-pass semi-permeable membrane barrier rejects additional dissolved solutes, some of which can be recycled back to the first-pass membrane, so that permeate with a low level of dissolved solutes is produced on the low pressure side of the second-pass membrane barrier.

This application claims priority of U.S. Provisional Patent Application Ser. No. 60/457,074 filed Mar. 24, 2003.

### FIELD OF INVENTION

The present invention relates to water treatment and, more specifically, to a method and system of removing solutes from an aqueous solution containing a high level of sparingly soluble inorganic solutes.

### BACKGROUND OF THE INVENTION

In conventional membrane desalination methods, the purity of the feed stream is usually limited by one or more sparingly soluble constituents in the feed stream, or by the inability of the soluble or sparingly soluble constituents to stay in solution as the concentration of the sparingly soluble constituents increases on the high pressure side of the membrane. A fraction of the soluble or sparingly soluble constituents eventually precipitates out during the membrane separation process, resulting in a decrease in liquid that permeates the membrane.

To overcome this problem, chemicals referred to as “antiscalants” have been added to the feed stream liquid prior to any reverse osmosis (RO) unit to increase the solubility of the sparingly soluble constituents. However, as the recovery rate is increased, the saturation points of the sparingly soluble compounds are eventually reached and precipitation occurs during the membrane separation process. Even with the addition of antiscalants, precipitation can occur because, as soluble or sparingly soluble constituents in the feed stream are rejected by the membrane, the concentration of such constituents increases at or near the membrane surface to a level that may be several times greater than the average concentration of such constituents. In prior processes, the precipitation of mineral compounds (scale) on the membrane surface could not be controlled, except by the addition of antiscalants or by inefficient operation at reduced recovery rates (e.g., constant repetitive shut-downs for cleaning, etc.). Often, these mineral deposits required the frequent cleaning and eventual replacement of the RO membranes.

### SUMMARY OF INVENTION

The present invention is directed to a system and method for removing solutes from an aqueous solution containing a high level of sparingly soluble inorganic solutes (for example, but not limited to, a waste water stream) in a manner that achieves a high recovery rate of the water content of the solution, as well as a high removal rate of the solutes contained in the solution in an efficient, continuous flow membrane process. The invention is particularly useful for producing product water with less than 500 mg/L of total dissolved solids (TDS) from initial feed streams containing between 3,000 and 20,000 mg/L of TDS with high levels of non-carbonate hardness (e.g., 1,000 to 2,500 mg/L of calcium and magnesium hardness expressed as calcium carbonate equivalents).

In the present membrane desalination method and system, dissolved sparingly soluble constituents in the system feed stream are removed ahead of an RO membrane separation device by employing a separate first-pass nanofiltration (NF) membrane. One such method involves a first-pass NF membrane separation process to remove sparingly soluble constitutes from the feed-stream solution by providing, at startup, an effective amount of suitable seed nucleation crystals in the fluid stream introduced to the NF membrane unit. Generally, the initial charge of seed nucleation crystals (e.g., CaSO₄) is the same material that is precipitated out of solution as the sparingly soluble solutes in the system feed stream (e.g., Ca²⁺ ions and SO₄²⁻ ions) are concentrated. By controlling the amount and size of nucleation crystals and maintaining the crystals in suspension in the fluid on the high pressure side of the NF membrane, the precipitation of the sparingly soluble solutes present in the system feed stream will occur upon the nucleation crystals, rather than on the membrane surface as mineral scale.

As an additional part of the present desalination system and method, a means is provided to separate the retentate stream from the first-pass NF membrane process into (i) a discharge stream containing a minority of the nucleation crystals and water content of the NF retentate, and (ii) a recycle stream containing a majority of the nucleation crystals and water content of the NF retentate. Before the discharge stream is discharged from the system, it may be further separated using a settling tank, hydrocyclone, or any other suitable solids/liquid separation device into (i) a fraction containing a higher level of suspended solids and (ii) a fraction containing a lower level of suspended solids. Different fractions of these separate streams may be discharged from the system to control independently the amount of dissolved solids and the amount of suspended solids that are returned to, or discharged from, the system. The recycle stream containing a majority of the nucleation crystals and water content of NF retentate stream is returned to the feed-side of the NF unit in a preferred embodiment. This configuration enables the majority of nucleation crystals to be reused in the process so that it is possible after startup to operate the system on a continuous basis without having to add nucleation crystals. Finally, in a preferred embodiment, a retentate stream from the second-pass RO unit is also recycled, at least in part, to the feed stream of the NF unit.

By providing and operating a double-pass membrane system in the manner described above, it is possible to recover high levels of high-hardness saline feed water as low salinity product water (<500 mg/L TDS) without fouling the membrane elements and without having to add scale inhibitors. The present invention also allows the simultaneous achievement of higher recovery rates and higher TDS rejection rates than would be possible in a single-pass design.

### BRIEF DESCRIPTION OF THE DRAWINGS

FIG. 1 is a schematic representation of a high recovery, high rejection, double-pass membrane process for desalinating water containing soluble and sparingly soluble inorganic materials in which the nucleation crystals used to effect the preferential precipitation of the sparingly soluble inorganic material in the first-pass membrane unit are returned to, and reused in, the process;

FIG. 2 is a schematic representation of the same water desalination process shown in FIG. 1 but with the addition of means for recycling a majority fraction of the preferential precipitation nucleation crystals directly to the feed stream of the first-pass membrane unit;

FIG. 3 is a schematic representation of the same water desalination process shown in FIG. 1 but with the addition of bypassing the first-pass membrane unit with a fraction of the system feed stream and feeding the fraction directly into the second-pass membrane unit;

FIG. 4 is a schematic representation of the same water desalination process shown in FIG. 1 but with the addition of providing means for heating the feed stream before the feed stream enters the first-pass membrane unit;

FIG. 5 is a schematic representation of the same water desalination process shown in FIG. 2 but with the addition of providing means for independently and instantaneously controlling the quantity of dissolved solids that leaves the system and the quantity of suspended solids that leaves the system so that steady-state operations can be maintained;

FIG. 6 is a schematic representation of the same water desalination process in shown FIG. 5 but with the addition of providing means for desuperaturating the solutions containing the nucleation crystals that are returned and reused to effect the preferential precipitation of the sparingly soluble solutes in the system feed stream in the first-pass membrane unit; and

FIG. 7 is a schematic representation of the same water desalination process shown in FIG. 5 but with the addition of providing means for reducing the agronomic sodium adsorption ratio of the system product water.

### DETAILED DESCRIPTION OF THE PREFERRED EMBODIMENTS

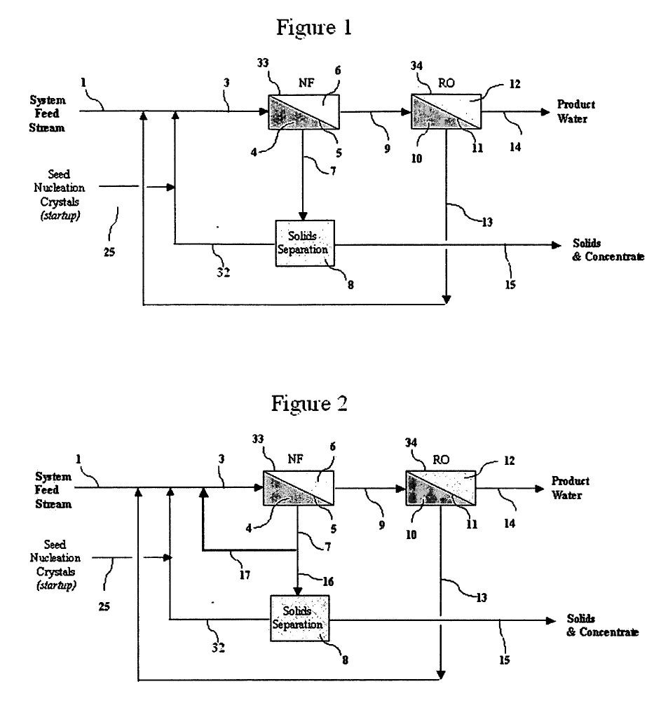

One embodiment of the present invention in which two membrane separation units are connected is shown in FIG. 1. In FIG. 1, first-pass membrane separation unit 33 is designated as a nanofiltration (NF) membrane, and second-pass membrane separation unit 34 is designated as a reverse osmosis (RO) unit. The use of these terms is not restrictive. The precise type of membrane used in each pass may vary depending on the application and desired performance of the system. For example, the first-pass membrane separation unit may be a multiple stage semi-permeable membrane barrier device.

In this embodiment, liquid feed stream 1 to be purified, e.g., hard water containing silica, calcium carbonate, calcium sulfate and suspended solids or wastewater or groundwater containing the same, is combined (i) with majority fraction stream 32 from the solids separation unit 8 containing a controlled amount of the nucleation crystals being returned to the process and (ii) with the retentate stream 13 from the second-pass membrane separation unit 34. These three combined streams form stream 3 which is pressurized and fed to the high pressure side 4 of the first-pass membrane separation unit 33 (e.g., NF in this embodiment).

Upon startup, seed nucleation crystals 25 are added to the system so that a sufficient quantity of nucleation crystals are initially present in stream 3 to achieve the preferential precipitation of the sparingly soluble solutes in stream 3 onto the nucleation crystals in the high pressure side 4 of the first-pass membrane separation unit 33. The required level of seed nucleation crystals will be whatever is necessary given operating conditions, but typically might be up to 50 g/L, and preferably will range from 10 g/L to 40 g/L. This quantity can be determined in advance by experimentation. The addition of nucleation crystals at startup can be made anywhere in the process (except streams 9, 14 and 15 in FIG. 1). FIG. 1 shows the startup nucleation crystals being added into stream 32 as one possibility.

In this embodiment, the feed stream 3 containing water, dissolved solids and nucleation crystals is conveyed to the high pressure side 4 of the first-pass membrane separation unit 33 wherein stream 3 is separated into a permeate stream 9 and a retentate stream 7. The membrane 5 used in the first-pass membrane separation unit 33 is selected so that a higher percentage of the dissolved divalent ions in stream 3 are rejected and concentrated in stream 7 as compared to the percentage of monovalent ions that are rejected and concentrated in stream 7. Correspondingly, a relatively higher percentage of the dissolved monovalent ions than divalent ions pass through the membrane 5 into the permeate stream 9 from the first-pass membrane separation unit 33. Preferably, a nanofiltration membrane with a divalent ion rejection rating >80% and a TDS rejection rating >65% is used as the membrane(s) 5 in the first-pass membrane separation unit 33.

All suspended solids in stream 3, including the nucleation crystals, are rejected by membrane 5 and are present in the retentate stream 7 that leaves the high pressure side 4 of the first-pass membrane separation unit 33. The mass of suspended solids increases on the high pressure side 4 of the first-pass membrane separation unit 33 because, as water permeates through membrane 5, the saturation limit of the rejected sparingly soluble inorganic solutes present in feed stream 3 is reached. This causes the solutes to precipitate out of solution on the high pressure side 4 of membrane 5. In this manner, the sparingly soluble solutes present in the system feed 1 are removed from solution without fouling first-pass membrane 5.

Because of the high level of solids (e.g., 10 to 40 g/L) that are intentionally maintained in suspension in the feed stream 3 and in the high pressure side 5 of the first-pass membrane separation unit 33, a preferred embodiment uses a polyamide thin film composite membrane in tubular construction for the first-pass membrane separation unit 33. The recovery rate achieved in the first-pass membrane separation unit 33 is not limited by the potential for sparingly soluble solutes to precipitate out of solution and foul the membrane 5. On the basis of these factors, a recovery rate in the range of about 75% is generally the optimal recovery rate for the first-pass membrane separation unit 33, although higher rates could be achieved.

The retentate stream from the first-pass membrane separation unit 33 is conveyed along line 7 to a solids separation device 8. The solids separation device 8 (e.g., gravity settling tank, centrifuge, hydrocyclone or filter) separates stream 7 into (i) a minority fraction stream 15 containing <50% of mass and volume flow rate of stream 7 and (ii) a majority fraction stream 32 containing ≧50% of mass and volume flow rate of stream 7. As shown in FIG. 1, minority fraction stream 15 is discharged from the system and majority fraction stream 32 is returned to the process as a component of feed stream 3 to the first-pass membrane separation unit 33. By recycling the majority fraction stream, namely majority fraction stream 32 from the solids separation device 8 to the feed stream 3 to the first-pass membrane separation unit 33, a majority of the nucleation crystals are returned and reused in the process. Thus, after startup, it is not necessary to add nucleation crystals to the process (i.e., the flow rate of stream 25 is zero at steady state) provided that the sum of the mass of solids leaving the desalination system in minority fraction stream 15 and in permeate stream 14 from the second-pass membrane separation unit 34 are controlled to be equal to or less than the mass of solids entering in the desalination system as a part of feed stream 1. For steady state operation, the sum of the mass of solids leaving the desalination system in lesser fraction discharge stream 15 and in permeate stream 14 from the second-pass membrane separation unit 34 must be controlled to equal the mass of solids entering the desalination system as a part of feed stream 1. In some cases, it may be necessary or desirable to reduce the size of the nucleation crystals in majority fraction stream 32 before they are returned to feed stream 3. If so, a comminution device (not shown in FIG. 1), such as a shear mixer or gear pump, may be placed in majority fraction stream 32.

Permeate from the first-pass membrane separation unit 33 is conveyed along line 9 and becomes the feed (under some pressure) to the second-pass membrane separation unit 34. The membrane 11 used in the second-pass membrane separation unit 34 is selected to achieve the desired level of purity of the product water stream 14. Typically, a reverse osmosis class membrane with a TDS rejection rating of >95% is used in the second-pass membrane separation unit so product water with <500 mg/L of TDS is produced.

The rate of production of permeate in the second-pass membrane separation unit 34 must be controlled to avoid precipitation of the sparingly soluble constituents in feed stream 9 on the high pressure side 10 of membrane 11. If the second-pass membrane separation unit 34 is operated at too great a recovery rate, precipitation of sparingly soluble solutes can occur on the high pressure side 10 of membrane 11. Because no nucleation crystals are present in stream 9, if the solubility limit of sparingly soluble solutes in stream 9 is reached as permeate 14 is produced on the low pressure side 12 of membrane 11, the precipitate that is produced can deposit on the membrane surface and foul the membrane 11. Thus, the recovery rate of second-pass membrane separation unit 34 must be controlled so as to avoid the precipitation of the sparingly soluble constituents in the feed stream 9 on the high pressure side 10 of membrane 11.

As shown in FIG. 1, the retentate stream 13 from the second-pass membrane separation unit 34 is returned to form part of the feed stream 3 to the first-pass membrane separation unit 33. By returning the retentate from the second-pass membrane separation unit 34 along with the majority fraction stream 32 from the first-pass membrane separation 33 unit to feed stream 3 to the first pass unit, overall recovery rates for the present desalination method of up to 99% can be achieved. For economic reasons, overall system recovery rates are generally limited to 90% to 95% (although not precisely) for feed streams containing between 5,000 and 15,000 mg/L TDS and product water TDS levels of <500 mg/L.

A second embodiment of the present invention is shown in FIG. 2. This embodiment is the same water desalination method as shown in FIG. 1, but with the addition of splitting the retentate stream 7 from the high pressure side 4 of the first-pass membrane separation unit 33 into two fractions. The first fraction stream 17 containing a majority (≧50%) of the mass and volume flow rate of stream 7 is conveyed to, and combined with, feed stream 3 to the first-pass membrane unit 34. In this manner, a majority of the nucleation crystals are returned to, and reused in, the first-pass membrane separation unit 33 without passing through the solids separation device 8. This configuration potentially affords reduced energy use and allows for use of a smaller solids separation device than the embodiment shown in FIG. 1.

The second fraction stream 16 containing a minority (<50%) of mass and volume flow rate of stream 7 is conveyed to the solids separation device 8. The solids separation device 8 (e.g., gravity settling tank, centrifuge, hydrocyclone or filter) separates stream 16 into (i) minority fraction stream 15 containing a higher concentration of suspended solids that is discharged from the system; and (ii) a majority stream 32 containing a lower concentration of suspended solids that is returned to the process as a component of feed stream 3 to the first-pass membrane separation unit 33. As above, the amount of solids leaving the desalination system in minority fraction stream 15 from the solids separation unit 8 is controlled so that the mass of solids leaving the desalination method in minority fraction stream 15 and in permeate stream 14 from the second-pass membrane separation unit 34 is equal to the mass of solids entering the system as a part of feed stream 1. In some cases, it may be necessary or desirable to reduce the size of the nucleation crystals in majority fraction stream 32 before they are returned to feed stream 3. If so, a comminution device (not shown in FIG. 2), such as shear mixer or gear pump, may be placed majority fraction stream 32.

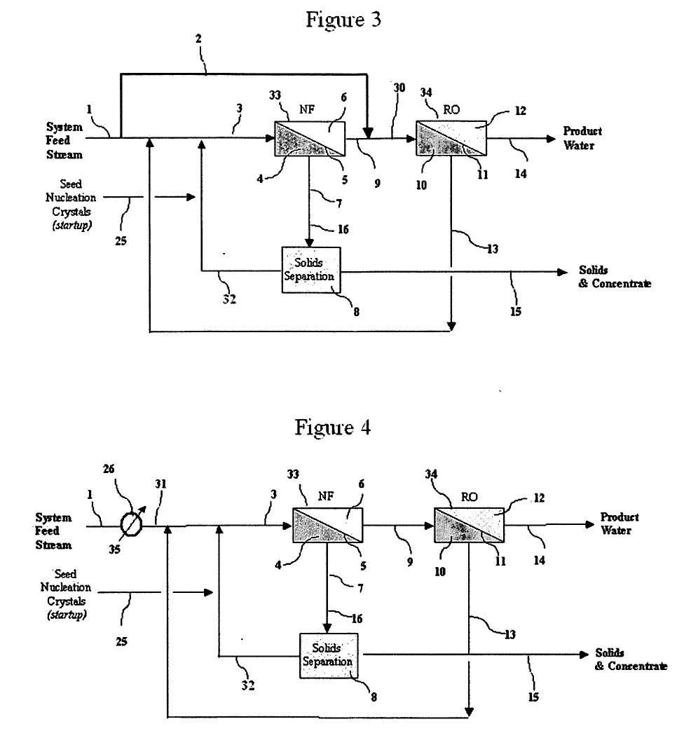

Another embodiment of the present invention is shown in FIG. 3. This embodiment is the same water desalination method as shown in FIG. 1 but with the addition of splitting the system feed stream 1 into two fractions. The first fraction 2 is conveyed to, and combined with, permeate stream 9 from the first-pass membrane separation unit 33 to form feed stream 30 to the second pass membrane separation unit 34. The second fraction of the system feed stream 1 is combined with stream 13 and majority fraction stream 32 to form feed stream 3 to the first-pass membrane separation unit 33. The advantage of operating the desalination method in this configuration is that a portion of the system feed bypasses the first-pass membrane separation unit 33 and is fed directly into the second-pass membrane separation unit 34. Such a configuration potentially reduces energy use and allows for use of a smaller first-pass membrane separation unit than is the case for the embodiment shown in FIG. 1.

The flow rate of stream 2 depends on the concentration of sparingly soluble solutes in stream 2 and in stream 9 and the recovery rate at which the second-pass membrane unit 34 is operated. The concentration level of sparingly soluble solutes in stream 9 depends on the rejection rate of the first-pass membrane 5 for the solutes. Use of this FIG. 2 configuration is limited to cases where the rejection rate achieved by the first-pass membrane 5 for sparingly soluble solutes is high enough that system feed water 2 can be directly blended into stream 9 without exceeding the concentration limit at which fouling may occur on membrane 11 given the recovery rate at which second-pass membrane separation unit 34 is operated.

Another embodiment of the present invention is shown in FIG. 4. This embodiment is the same water desalination method as shown in FIG. 1 but with the addition of heating means 26 for heating the desalination system feed stream 1 using an external heat source 35. The heating means 26 used to heat the system feed stream 1 could be, for example, a heat exchanger or a salinity gradient solar pond. The heat source could be, for example, heat produced by burning carbonaceous fuels, waste heat from other operations, or solar radiation. The desired effect of this embodiment of the present invention is to increase the temperature of the desalination system feed stream 1 so that the temperature of stream 31 after being heated is 10° C. to 40° C. higher than the ambient temperature of the system feed stream 1. By heating the system feed in this manner, the first-pass membrane 5 and the second-pass membrane 11 will be able to operate at 40% to 60% higher flux rates than the flux rates achieved when the ambient system feed stream 1 temperature is, for example, 18° C. Such improved membrane flux rates reduce energy use and lower capital costs.

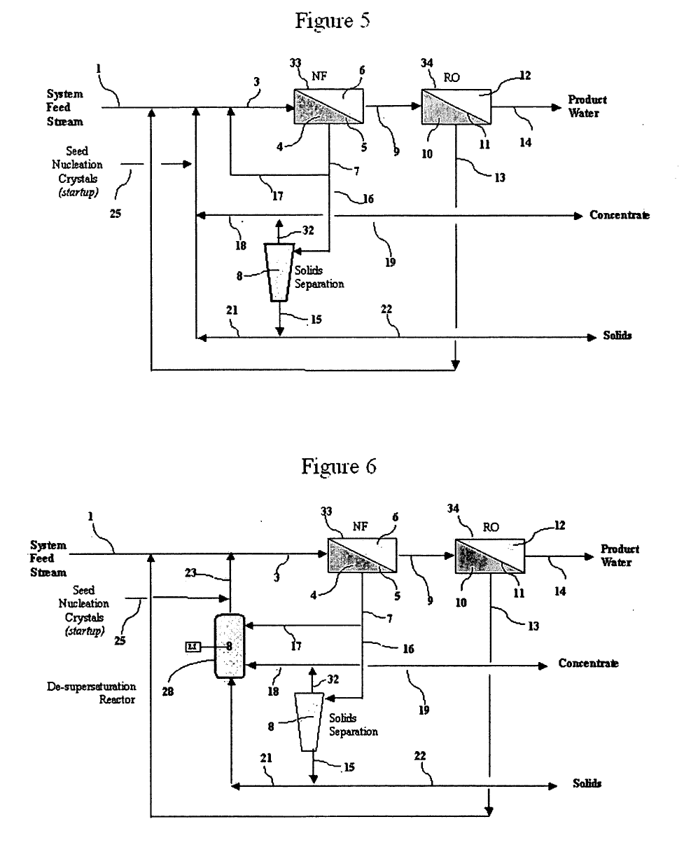

Another embodiment of the present invention is shown in FIG. 5. This embodiment is the same water desalination system shown in FIG. 2 but with the addition of means for (i) splitting minority fraction stream 15 (the stream containing the high level of suspended solids) leaving solids separation device 8 into two fractions (a recovery stream 21 and a discharge stream 22); and (ii) splitting majority fraction stream 32 (the stream containing the lower level of suspended solids) leaving the solids separation device 8 into two fractions (a recovery stream 18 and a discharge stream 19). In this embodiment, use of solids separation device 8 whose operation can be instantaneously adjusted and controlled, such as a hydrocyclone or centrifuge, is preferred. The first fraction of the split stream with a high level of suspended solids, namely discharge stream 22, is discharged from the system, while the second, recovery fraction 21 is returned to, and combined with, the streams comprising the feed stream 3 to the first-pass membrane unit. Similarly, the first, discharge fraction 19 of the split stream with a low level of suspended solids 32 is discharged from the system. The second, recovery fraction 18 is returned to, and combined with, the streams comprising the feed stream 3 to first-pass membrane unit. This configuration permits the quantity of dissolved solids that is discharged from the system, and the quantity of suspended solids that is discharged from the system, to be independently determined and adjusted by varying the ratio of stream 18 to stream 19 and the ratio stream 21 to discharge stream 22. With this capability, it is possible to operate the desalination method on a continuous, steady-state basis (i.e., maintain a solids and water mass balance) at a desired water recovery ratio.

Still another embodiment of the present invention is shown in FIG. 6. This embodiment is the same system and method shown in FIG. 5 but with the addition of desupersaturating means 28 for desupersaturating the solutions containing the preferential precipitation nucleation crystals (streams 17, 18 and 21 in FIG. 6) before the crystals are reused in the process.

The means for desupersaturation in this embodiment may consist of, for example, reactor vessel with a mechanical stirrer 60. After desupersaturation, the solution containing the nucleation crystals is conveyed along line 23 and combined with the system feed stream 1 to form the feed stream 3 to the first-pass membrane separation unit 33. The desired effect of providing the desupersaturating means 28 as part of the present desalination system and method is to allow a greater fraction of the crystals to exist in suspension, as opposed to being dissolved in a supersaturated solution, before the crystals are returned to, and reused in, the first-pass membrane separation unit 33. By increasing the quantity of nucleation crystals in suspension, as opposed to supersaturation, in the return flow stream 23, the effectiveness of the preferential precipitation anti-fouling effect on the high pressure side 4 of the membrane 5 used in the first-pass membrane separation unit 33 is enhanced.

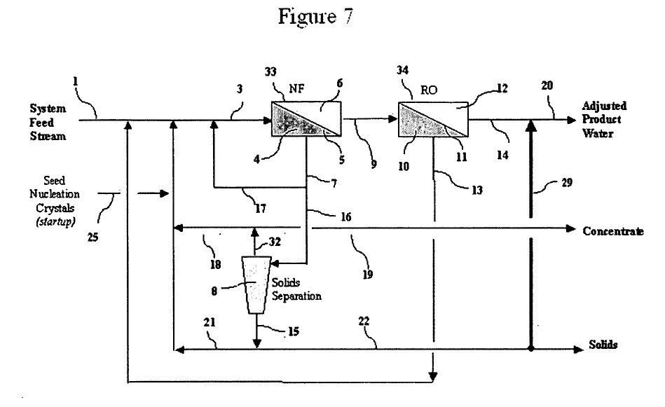

Another embodiment of the present invention is shown in FIG. 7. This embodiment is the same water desalination system shown in FIG. 5 but with the addition of adjustment means 29 for reducing the agronomic sodium adsorption ratio of the permeate stream 14 from the second-pass membrane unit 34.

This embodiment is particularly useful in cases where the product water produced is used as agricultural irrigation water. In such applications, the permeate stream 14 from the second-pass membrane separation unit 34 will, in most cases, have an unfavorable ratio of sodium ions to the sum of calcium and magnesium ions. Because of this unfavorable ratio (computed as the so-called “sodium adsorption ratio” of the water), the product water will not penetrate into soil at an acceptable rate. This deficiency exists because the reverse osmosis class of membranes, as typically used for membrane 11 in the second-pass membrane separation unit 34, characteristically reject a greater percentage of divalent ions (e.g., calcium and magnesium) than monovalent ions (e.g., sodium). As a means for correcting this deficiency, a fraction of the solids that are present in process stream 22, when those solids are principally calcium sulfate, are mixed with the permeate stream 14 from the second-pass membrane unit 34 to produce an adjusted product water 20 that has a higher concentration of calcium (and thus a lower sodium adsorption ratio) than permeate stream 14. The adjusted product water 20 has more utility for use as agricultural irrigation water than permeate stream 14.

Exemplary Embodiment

In an exemplary embodiment of the above-described system and method, an on-farm treatment and recycling plant could be provided. For purposes of illustration, consider such a hypothetical plant and the performance of the present invention in accordance with calculations made by a computer model that would treat 15 gallons per minute (GPM) of agricultural drainage water. The numbers shown below are consistent with what would be typical for a system of the present invention, but are intended for illustrative purposes only. No limitations on the invention should be inferred from this predictive model.

In this illustration, salinated water having a hardness of 2,061 mg/L (with TDS of 6,450 mg/L and a pH of 7.5) and the composition shown in TABLE I, could be passed through a cartridge filter and split into a by-pass stream fed directly to a second semi-permeable membrane barrier, and a primary feed stream fed to a first semi-permeable membrane barrier.

TABLE I

| COMPONENT | AMOUNT (mg/L) |
|---|---|
| Ca²⁺ | 540 |
| Mg²⁺ | 173 |
| Na⁺ | 1,248 |
| SO₄²⁻ | 3,100 |
| Cl⁻ | 745 |
| HCO₃ | 280 |
| NO₃ | 312 |
| SiO₂ | 24 |
| Se | 0.3 |
| B | 12 |
| Other | 16 |

The first semi-permeable membrane barrier apparatus in this embodiment could be a two-stage tubular nanofiltration apparatus consisting of nine (9) parallel pathways of ½″ diameter tubular membranes with a total path length of 864 feet followed by 5 parallel pathways of ½″ diameter tubular membranes with total path length of 864 feet. The tubes are contained in modules to create this flow pattern. The feed would be, of course, pressurized. Pressurization could be achieved either through a raised, gravity-released feed tank or pumps, or any combination thereof. The total membrane area of this embodiment for the first semi-permeable membrane would be 1,574 ft². In this embodiment, some of the permeate stream from the first stage could bypass the second stage.

In accordance with the invention as described above, the permeate stream from the first semi-permeable membrane apparatus would be sent to the second semi-permeable membrane barrier, and (in this example embodiment) the retentate stream would be split into two streams, namely a majority fraction which would be sent to a desupersaturation device, and a minority fraction stream which would be sent to a solids separation device. In this exemplary embodiment, the solids separating device would be a hydrocyclone. The desupersaturation reactor vessel would be a 300 gallon stirred tank vessel. The output from the desupersaturation vessel would be sent back to the feed to the first semi-permeable membrane barrier device. The output stream from the solids separation device (as noted above, for example with respect to FIG. 5) would be split into two streams. The discharge fraction in this embodiment would produce over 100 pounds of gypsum per day.

The second semi-permeable membrane barrier of this embodiment would be a reverse osmosis device (spiral-type) comprised of a 20 foot long 3×6 array of 4×″40″ elements (18 elements total). As with the first semi-permeable membrane barrier device, the feed stream would be pressurized. This could be done, as above, with both a gravity feed tank and booster pump. The permeate stream from the second semi-permeable membrane barrier device (spiral RO) would have a TDS content of 149 mg/L. The compositional breakdown of such a stream under such conditions is summarized in Table II below.

TABLE II

| COMPONENT | AMOUNT (mg/L) |
|---|---|
| Ca²⁺ | 0.5 |
| Mg²⁺ | 0.3 |
| Na⁺ | 46 |
| SO₄²⁻ | 12 |
| Cl⁻ | 21 |
| HCO₃ | 10 |
| NO₃ | 56 |
| SiO₂ | 0.1 |
| Se | 0.001 |
| B | 3.9 |

In this exemplary embodiment, and as noted above with respect to FIG. 7, the RO permeate stream can be modified by adding content from the discharge fraction of the solids separating device (namely, gypsum). If this was done, an adjusted product water stream could be achieved having a TDS of 270 mg/L and a compositional breakdown as summarized in Table III.

TABLE III

| COMPONENT | AMOUNT (mg/L) |
|---|---|
| Ca²⁺ | 32.6 |
| Mg²⁺ | 0.7 |
| Na⁺ | 50 |
| SO₄²⁻ | 93 |
| Cl⁻ | 23 |
| HCO₃ | 10 |
| NO₃ | 57 |
| SiO₂ | 0.1 |
| Se | 0.002 |
| B | 4.0 |

As used in all of the above descriptions of the present invention, sparingly soluble constituents include carbonates, silicates, sulfates, phosphates, fluorides and hydroxides of metals such as aluminum, barium, calcium, magnesium, strontium, chromium, copper, lead, nickel, silver, tin, titanium, vanadium, zinc and other multivalent cations of the periodic table. Other soluble constituents that may be treated include the salts of organic materials such as, for example, carboxylic acids, polymeric compounds (polyelectrolytes that may exist in salt forms), alcohols and hydrocarbons. The salts are formed when the sparingly soluble constituents are concentrated and precipitate out of solution to form mineral scale deposits on the membrane surface on the high pressure side of the membrane. The exact concentration at which precipitation occurs depends on the solubility limit of the specific salt and the conditions present in the system (e.g., temperature, pH, and TDS level). In contrast, highly soluble salts will pass through the membrane and, therefore, will not precipitate and form mineral scale on the membrane surface.

1. A method for desalinating a solution containing sparingly soluble solutes comprising the steps of:
(a) introducing a solution having sparingly soluble solutes and nucleation crystals to the high pressure side of a first semi-permeable membrane barrier to produce a retentate stream on the high pressure side of the first semi-permeable membrane barrier, and a permeate stream on the low pressure side of the first semi-permeable membrane barrier having reduced concentrations of the sparingly soluble solutes;
(b) introducing the permeate stream produced in step (a) to the high pressure side of a second semi-permeable membrane barrier to produce a second retentate stream on the high pressure side of the second semi-permeable membrane barrier, and a product stream on the low pressure side of the second semi-permeable membrane barrier with substantially lower concentrations of sparingly soluble and soluble solutes compared to the solution initially introduced in step (a); and
(c) returning a majority fraction of the retentate stream rejected by the first semi-permeable membrane barrier containing a majority of the nucleation crystals to the solution that is introduced to the high pressure side of the first semi-permeable membrane barrier.

2. The method of claim 1 further comprising the step:
(d) returning a majority fraction of the second retentate stream rejected by the second semi-permeable membrane barrier to the solution that is introduced into the high pressure side of the first semi-permeable membrane barrier.

3. The method of claim 1 wherein the initial solution is a heated saline solution.

4. The method of claim 1 wherein a portion of the solution introduced to the high pressure side of the first semi-permeable membrane barrier in step (a) is bypassed around the first semi-permeable membrane barrier and is introduced to the high pressure side of the second semi-permeable membrane barrier.

5. The method of claim 1 wherein a majority fraction of the retentate stream rejected by the first semi-permeable membrane barrier containing a majority of the nucleation crystals is desupersaturated before said stream is returned to the solution introduced to the high pressure side of the first semi-permeable membrane barrier.

6. The method of claim 1 wherein the first semi-permeable membrane barrier is a nanofiltration membrane.

7. The method of claim 1 wherein the second semi-permeable membrane barrier is a reverse osmosis membrane.

8. The method of claim 1 wherein the first semi-permeable membrane barrier is contained in tubular membrane modules.

9. The method of claim 1 wherein the second semi-permeable membrane barrier is contained in spiral-wound membrane elements.

10. The method of claim 1 wherein the sparingly soluble solutes in the initial solution include calcium, sulfate and silica.

11. The method of claim 1 wherein the nucleation crystals in the solution of step (a) which is added to the high pressure side of the first semi-permeable membrane barrier are added to the solution upon startup, and are selected from the group consisting of calcium sulfate, calcium carbonate, calcium phosphate, and silica.

12. The method of claim 1 wherein the initial solution is a saline solution comprised of water containing between 3,000 and 20,000 mg/L of total dissolved solids.

13. The method of claim 1 wherein the solution produced on the low pressure side of the second semi-permeable membrane barrier is water containing less than 500 mg/L of total dissolved solids.

14. The method of claim 1 wherein the water content of the product stream produced on the low pressure side of the second semi-permeable membrane barrier is greater than or equal to 80% of the water content of the solution introduced to the high pressure side of the first semi-permeable membrane barrier.

15. The method of claim 1 wherein the solution introduced to the high pressure side of the first semi-permeable membrane barrier is agricultural drainage water.

16. The method of claim 1 wherein the solution introduced to the high pressure side of the first semi-permeable membrane barrier is groundwater.

17. The method of claim 1 wherein the solution introduced to the high pressure side of the first semi-permeable membrane barrier is a brine stream produced in a separate water treatment process.

18. A method of desalinating a saline solution containing sparingly soluble solutes comprising the steps of:
(a) introducing a saline solution containing sparingly soluble solutes and nucleation crystals to the high pressure side of a first semi-permeable membrane barrier to produce a retentate stream on the high pressure side of the first semi-permeable membrane barrier, and a permeate solution on the low pressure side of the first semi-permeable membrane barrier containing reduced concentrations of the sparingly soluble solutes;
(b) introducing the permeate solution produced on the low pressure side of the first semi-permeable membrane barrier to the high pressure side of a second semi-permeable membrane barrier to produce a second retentate stream on the high-pressure side of the second semi-permeable membrane barrier, and a product solution on the low pressure side of the second semi-permeable membrane barrier with substantially lower concentrations of sparingly soluble and soluble solutes compared to the saline solution initially introduced in step (a);
(c) separating the retentate stream rejected by the first semi-permeable membrane barrier into a majority fraction solution containing a majority of the nucleation crystals and a minority fraction solution containing a minority of the nucleation crystals;
(d) returning the majority fraction solution directly to the saline solution that is introduced to the high pressure side of the first semi-permeable membrane barrier;
(e) separating the minority fraction solution into: (i) a first-fraction solution with a higher level of suspended solids, and (ii) a second-fraction solution with a lower level of suspended solids;
(f) returning a portion of the first-fraction solution with a higher level of suspended solids to the saline solution that is introduced to the high pressure side of the first semi-permeable membrane barrier; and
(g) returning the second retentate stream to the saline solution that is introduced to the high pressure side of the first semi-permeable membrane barrier.

19. The method of claim 18 wherein the separation of the minority fraction solution in step (e) is accomplished using a gravity settling tank, centrifuge, hydrocyclone or filter.

20. The method of claim 18 wherein the first-fraction solution with a higher level of suspended solids is further split into (i) a discharge fraction and (ii) a recovery fraction with the recovery fraction being returned and introduced into the saline solution that is introduced into the high pressure side of the first semi-permeable membrane barrier.

21. The method of claim 18 wherein the second-fraction solution with a lower level of suspended solids is further split into (i) a discharge fraction and (ii) recovery fraction with said recovery fraction being returned and introduced into the saline solution that is introduced into the high pressure side of the first semi-permeable membrane barrier.

22. The method of claim 18 wherein a fraction of the discharge fraction is combined with the product stream produced on the low pressure side of the second semi-permeable membrane barrier to effect a reduction in the agronomic sodium adsorption ratio of said solution.

23. The method of claim 18 wherein the initial saline solution is heated.

24. The method of claim 18 wherein saline solution is introduced into the high pressure side of the second semi-permeable membrane barrier which does not pass through the first semi-permeable membrane barrier.

25. The method of claim 18 wherein the retentate stream rejected by the first semi-permeable membrane barrier containing a majority of the nucleation crystals is desupersaturated before the solution is returned to the high pressure side of the first semi-permeable membrane barrier.

26. The method of claim 18 wherein the first semi-permeable membrane barrier is selected from the class of nanofiltration membranes.

27. The method of claim 18 wherein the second semi-permeable membrane barrier is selected from the class of reverse osmosis membranes.

28. The method of claim 18 wherein the first semi-permeable membrane barrier is contained in tubular membrane modules.

29. The method of claim 18 wherein the second semi-permeable membrane barrier is contained in spiral-wound membrane elements.

30. The method of claim 18 wherein the sparingly soluble solutes in the initial saline solution are calcium sulfate and silica.

31. The method of claim 18 wherein the seed nucleation crystals added upon startup are selected from the group of calcium sulfate, calcium carbonate, calcium phosphate, and silica.

32. The method of claim 18 wherein the initial saline solution is water containing between 3,000 and 20,000 mg/L of total dissolved solids.

33. The method of claim 18 wherein the solution produced on the low pressure side of the second semi-permeable membrane barrier is water containing less than 500 mg/L of total dissolved solids.

34. The method of claim 18 wherein the water content of the solution produced on the low pressure side of the second semi-permeable membrane barrier is greater than or equal to 80% of the water content of the initial saline solution.

35. The method of claim 18 wherein the initial saline solution is agricultural drainage water.

36. The method of claim 18 wherein the initial saline solution is groundwater.

37. The method of claim 18 wherein the initial saline solution is the brine stream produced in a separate water treatment process.

38. A system for desalinating a solution containing soluble and sparingly soluble solutes comprising:
(a) a first semi-permeable membrane barrier having a high-pressure side and a low-pressure side for receiving a feed stream on the high-pressure side and producing:
a permeate stream on the low-pressure side having reduced concentrations of sparingly soluble solutes as compared to the feed stream, and
a first retentate stream on the high-pressure side;
(b) a second semi-permeable membrane barrier having a low pressure side and a high-pressure side in fluid communication with, and downstream of, the first semi-permeable membrane for receiving the permeate stream on the high-pressure side and producing:
a second retentate stream on the high-pressure side, and
a product water stream on the low-pressure side having substantially lower concentrations of sparingly soluble and soluble solutes compared to the feed stream; and
(c) means for separating solids from the first retentate stream into a first fraction solution having a higher level of suspended solids and a second fraction solution with a lower level of suspended solids, said solid separating means in fluid communication with the high-pressure side of the first semi-permeable membrane.

39. The system of claim 38 wherein said separating means is selected from the group consisting of: a gravity settling tank, a centrifuge, a hydrocyclone and a filter.

40. The system of claim 38 further comprising means for joining a stream from the solid separating means and a stream from the high-pressure side of the second semi-permeable membrane with the feed stream.

41. The system of claim 38 further comprising:
(d) means for separating the first retentate stream into a majority fraction solution and a minority fraction solution upstream of said solid-separating means, wherein said minority fraction solution is in fluid communication with said solid separating means and said majority fraction solution is in fluid communication with said high-pressure side of said first semi-permeable membrane barrier.

42. The system of claim 38 further comprising:
(d) means for passing a portion of the feed stream directly to the high-pressure side of the second semi-permeable membrane.

43. The system of claim 38 further comprising:
(d) means for heating the feed stream.

44. The system of claim 38 further comprising means for splitting said first fraction solution into a high-solid recycle stream and a high-solid discharge stream.

45. The system of claim 38 including means for splitting said second fraction solution into a low-solid recycle stream and a low-solid discharge stream.

46. The system of claim 41 further including desupersaturating means to receive said majority fraction solution and said second fraction solution.

47. The system of claim 46 wherein said desupersaturating means is a stirred vessel.

48. The system of claim 44 further including adjustment means for controlling the agronomic sodium absorption ratio of said product water stream, said adjustment means allowing a controlled amount of said high-solid discharge stream to be added to said product water stream.
